(19) United States
(12) Patent Application Publication
(10) Pub. No.: US 2007/0019742 A1
(43) Pub. Date: Jan. 25, 2007

(54) Method of transmitting pre-encoded video

(76) Inventor: Kevin E. Davis, North Reading, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/490,333

(22) Filed: Jul. 20, 2006

Related U.S. Application Data
(60) Provisional application No. 60/701,565, filed on Jul. 22, 2005.

(51) Int. Cl. H04N 7/12

(52) U.S. Cl. 375/240.26

(57) ABSTRACT

A method, apparatus and computer program product for providing transmittal of pre-encoded video is presented. A video sequence is encoded with a first set of parameters to produce a first pre-encoded video. The video sequence is then encoded with a second set of parameters to produce a second pre-encoded video, the second set of parameters different than the first set of parameters. The first pre-encoded video is transmitted and, during transmittal of said first pre-encoded video, a switch is made to the second pre-encoded video at an intra encoding point such that no visual disturbance is perceived by a receiver of said pre-encoded videos.

### CROSS REFERENCE TO RELATED APPLICATIONS

The present application claims the benefit of U.S. Provisional Patent Application No. 60/701,565, filed on Jul. 22, 2005, which is incorporated herein by reference.

### BACKGROUND

In general, transmission of media data (e.g. audio, video, etc.) over a network involves encoding the media prior to transmit and subsequently decoding after being received. Each particular algorithm for coding and decoding is known as a codec. Though codec complexity varies, significant processing resources are often required.

To eliminate or reduce real-time encoding requirements, media can be encoded in advance (pre-encoded), saved, then subsequently played-back or transmitted with very low resource requirements. Video (motion pictures) generally consists of a series of still pictures. Coding of the still images can be broadly grouped into two categories, coding which depends upon other images in the sequence and coding which does not depend upon any other image. When no dependency exists, this is called intra coding. When dependencies exist, this is called inter coding or predictive coding. Video compression algorithms (e.g. H.263, MPEG-2, MPEG-4, etc.) utilize inter coding techniques because the data size is substantially smaller.

### SUMMARY

Conventional mechanisms such as those explained above suffer from a variety of deficiencies. In some cases, pre-encoding may have a significant drawback, such as the inability to respond to real-time dynamics. In particular, this drawback is true for video because video encoding commonly needs adjustment based upon dynamic considerations. These considerations may include controls from the local user, controls from the remote receiver, control from network devices, network errors or network bandwidth changes. For example, a remote receiver may request Fast Picture Update (re: ITU-T recommendation H.245). For another example, prevailing network error conditions may dictate that the transmitter adjust its output bit rate to compensate.

However, intra pictures are sent occasionally because long sequences of inter/predicted pictures, without any intra pictures, are susceptible to errors, error persistence and error propagation.

Embodiments of the invention significantly overcome such deficiencies and provide mechanisms and techniques that provide a transmittal of pre-encoded video.

In a particular embodiment of a method for providing transmittal of pre-encoded video, a video sequence is encoded with a first set of parameters to produce a first pre-encoded video. The same video sequence is also encoded with a second set of parameters to produce a second pre-encoded video. The second set of parameters is different than the first set of parameters. Transmittal of the first pre-encoded video is then started. During transmittal of the first pre-encoded video, a switch is made to the second pre-encoded video at an intra encoding point such that no visual disturbance is received by a receiver of the pre-encoded videos.

Other embodiments include a computer readable medium having computer readable code thereon for providing transmittal of pre-encoded video. The medium includes instructions for encoding a video sequence with a first set of parameters to produce a first pre-encoded video. The medium also includes instructions for encoding the video sequence with a second set of parameters to produce a second pre-encoded video, the second set of parameters different than the first set of parameters. The medium also includes instructions for beginning transmittal of the first pre-encoded video and instructions for switching, during the transmittal of the first pre-encoded video, to the second pre-encoded video at an intra encoding point such that no visual disturbance is received by a receiver of the pre-encoded videos.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides transmittal of pre-encoded video as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing transmittal of pre-encoded video as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Empirix Inc. of Bedford Mass.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a block diagram of a system for transmitting pre-encoded video;

FIG. 2 illustrates an example of a fast picture update sequence of events;

FIG. 3 illustrates a flow diagram of a particular embodiment of a method for transmitting pre-encoded video in accordance with embodiments of the invention; and

FIG. 4 illustrates an example computer system architecture for a computer system that performs transmittal of pre-encoded video in accordance with embodiments of the invention.

### DETAILED DESCRIPTION

Byt way of the presently described method of transmitting pre-encoded video, a video sequence is encoded more than once, each encoding operation performed with different parameters (e.g. different bit rates and/or intra-encoding). The encoded video is then transmitted, wherein the transmit function initially draws upon one particular variation of the pre-encoded video and can seamlessly switch to a different variation of the pre-encoded video because the switch between the different pre-encodede videos occurs only at intra encoding points of the video stream.

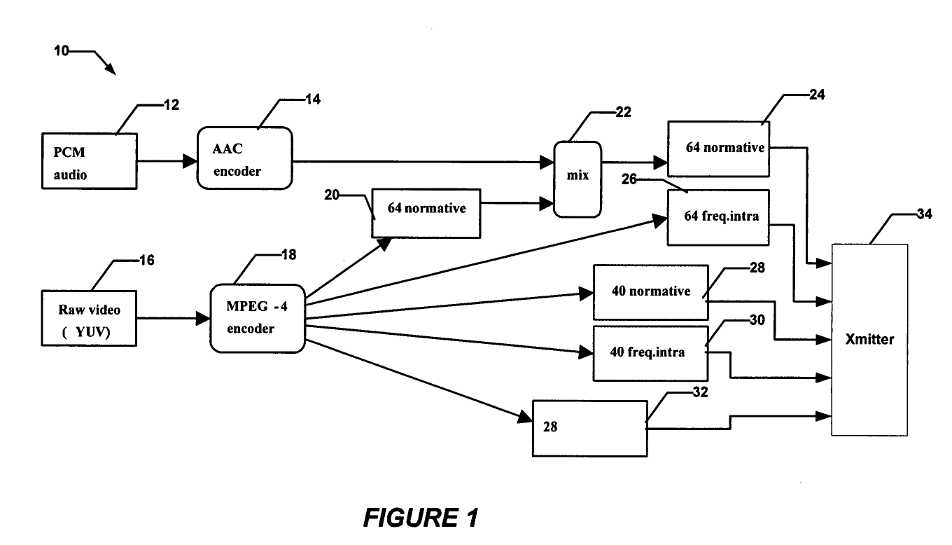

FIG. 1 illustrates a particular example of pre-encoding of video with two parameters, bit-rate and amount of intra-encoding. Raw video (YUV) 16 is provided to an encoder 18 such as an MPEG-4 encoder. The encoder 18 outputs a plurality of different encoded videos. For example, the encoder 18 may provide an output at 64 KBit/sec with intra encoding at frequent intervals (26), 64 KBit/sec with less-frequent intra encoding (20), 40 KBit/sec with intra encoding at frequent intervals (30), 40 KBit/sec with less-frequent intra encoding (28) and 28 KBit/sec (32).

In one instance, the pre-encoded media file includes both video and audio. In this example the audio is shown as PCM audio 12 and is provided to an Advanced Audio Coding (AAC) encoder 14. The output of the AAC encoder 14 is provided to a mixer 22. Mixer 22 also receives the 64 KBit/sec with less-frequent intra encoding 20 and mixes the audio and video inputs to provide a 64 KBit/sec with less-frequent intra encoding output 24 that includes an audio component. The various pre-encoded videos are provided to a transmitter 34 for distribution to an intended receiver.

In use, a receiver may request that the transmitter send intra encoding. A network device, such as multi-point control unit (MCU) may also request that the transmitter send intra encoding; such change to intra coding is sometimes referred to as Fast Picture Update. There is no way to respond to this request if the video is rigidly pre-encoded just once. However, if the video is encoded more than once, with varying amounts of intra coding, the transmitter can dynamically switch to an encoding with more intra. Subsequently, the transmitter can return back to the normative encoding (less intra). Because the switch occurs on intra pictures, the switch incurs no visual disturbance. In a particular embodiment the switching is performed dynamically, in response to a real-time stimulus.

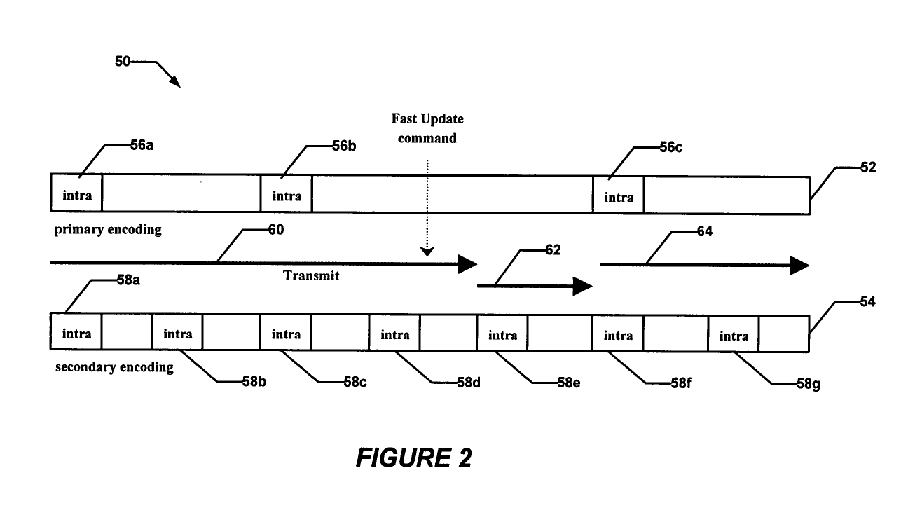

Referring now to FIG. 2, an environment 50 is presented wherein two encodings of the same video are shown. Primary encoding 52 is shown having relatively few intra periods 56a-56c. Secondary encoding 54 has more intra periods 58a-58g. During transmittal of the primary encoding, shown by arrow 60, a Fast Update Command is received. The transmittal is therefore switched to secondary encoding 54 at intra period 58e, and the secondary encoding is transmitted as shown by arrow 62. At the next intra period 56c of the primary encoding, the transmittal is switched back to primary encoding 52, as indicated by arrow 64.

A similar example involves a mobile phone (audio/video) communicating with a computer on an IP network through a mobile-to-IP gateway. The communication utilizes an Adaptive Multi-Rate (AMR) audio channel and a 40 Kbps MPEG-4 video channel, multiplexed (H.223) into a single 64 Kbps data channel. Video is initially 40 Kbps in both directions; the IP-based computer transmits a 40 Kbps normative encoding. Subsequently, network errors occur and an indication is sent to the IP-based computer. The computer switches its video transmit to a 28 Kbps encoding. If the error rate decreases, video transmit can switch back to the 40 Kbps encoding. Because the switch occurs on intra pictures, the switch incurs no visual disturbance.

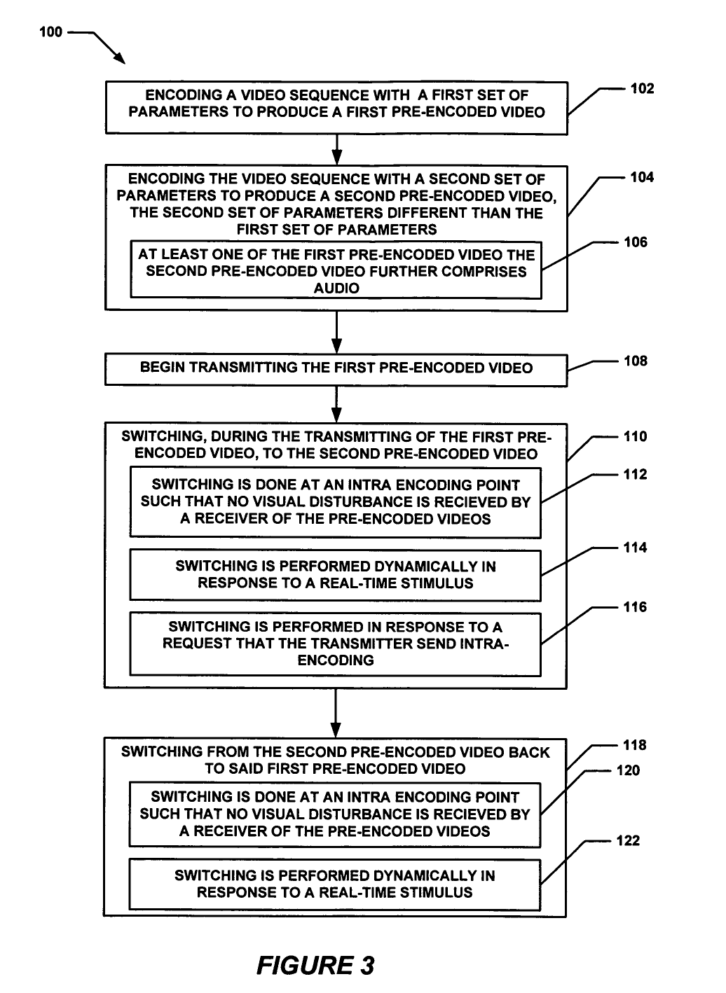

A flow chart of a particular embodiment of the presently disclosed method is depicted in FIG. 3. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, a particular embodiment of a method 100 for providing transmittal of pre-encoded video is shown. The method begins with processing block 102 wherein a video sequence is encoded with a first set of parameters to produce a first pre-encoded video. In processing block 104, the same video sequence is encoded with a second set of parameters to produce a second pre-encoded video. The second set of parameters is different than the first set of parameters. Processing block 106 recites that at least one of the pre-encoded videos may also include audio. The audio is encoded separately and then combined with the video to provide a video that includes an audio component.

Processing continues with processing block 108 wherein transmittal of the first pre-encoded video is started. As shown in processing block 110, during transmittal of the first pre-encoded video, a switch is made to the second pre-encoded video. As depicted in processing block 112 the switching is performed at an intra encoding point such that no visual disturbance is received by a receiver of the pre-encoded videos. As recited in processing block 114, the switching from the first pre-encode video to the second pre-encoded video is preformed in response to a real-time stimulus. As further recited in processing block 116 the switching is performed in response to a request that the transmitter send intra-encoding. The request may be realized as a Fast Update Command or in response to network conditions.

Processing block 118 discloses switching back from the second pre-encoded video to the first pre-encoded video. Processing block 120 states that the switching back occurs at an intra-encoding point such that no visual disturbance is received by a receiver of the pre-encoded videos. As recited in processing block 122, the switching from the second pre-encode video to the first pre-encoded video is preformed in response to a real-time stimulus.

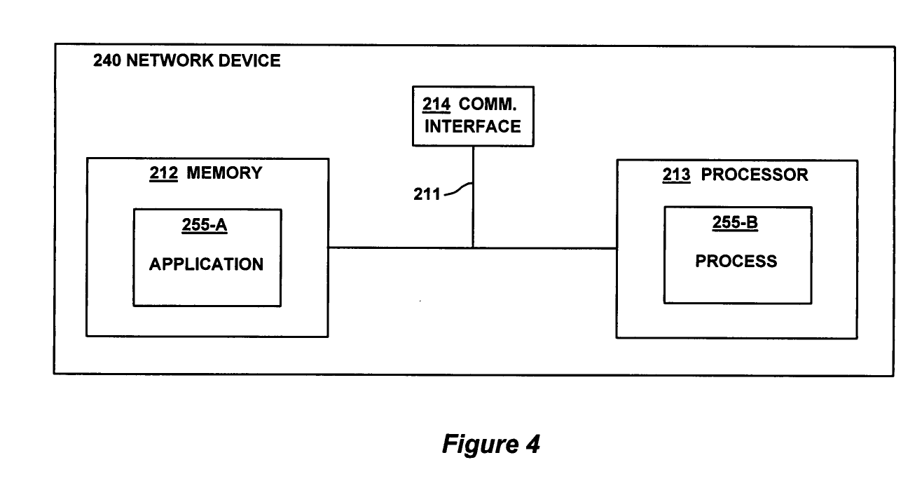

FIG. 4 illustrates example architectures of a computer system that is configured as a system 240. The system 240 may be any type of computerized system such as a personal computer, workstation, portable computing device, mainframe, server or the like. In this example, the system includes an interconnection mechanism 211 that couples a memory system 212, a processor 213, and a communications interface 214. The communications interface 214 allows the computer system 240 to communicate with external devices or systems.

The memory system 212 may be any type of computer readable medium that is encoded with an application 255-A that represents software code such as data and/or logic instructions (e.g., stored in the memory or on another computer readable medium such as a disk) that embody the processing functionality of embodiments of the invention for the agent 255 as explained above. The processor 213 can access the memory system 212 via the interconnection mechanism 211 in order to launch, run, execute, interpret or otherwise perform the logic instructions of the applications 255-A for the host in order to produce a corresponding process 255-B. In other words, the process 255-B represents one or more portions of the application 255-A performing within or upon the processor 213 in the computer system.

It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 212 (e.g., within random access memory or RAM). It is also to be understood that other embodiments of the invention can provide the applications operating within the processor 213 as the processes. While not shown in this example, those skilled in the art will understand that the computer system may include other processes and/or software and hardware components, such as an operating system, which have been left out of this illustration for ease of description of the invention.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of providing transmittal of pre-encoded video comprising:
encoding a video sequence with a first set of parameters to produce a first pre-encoded video;
encoding said video sequence with a second set of parameters to produce a second pre-encoded video, said second set of parameters different than the first set of parameters;
beginning transmittal of said first pre-encoded video;
switching, during said transmittal of said first pre-encoded video, to said second pre-encoded video at an intra encoding point such that no visual disturbance is received by a receiver of said pre-encoded videos.

2. The method of claim 1 further comprising switching from said second pre-encoded video to said first pre-encoded video at an intra encoding point such that no visual disturbance is received by a receiver of said pre-encoded videos.

3. The method of claim 1 wherein said switching from said first pre-encoded video to said second pre-encoded video is performed dynamically, in response to a real-time stimulus.

4. The method of claim 2 wherein said switching from said second pre-encoded video to said first pre-encoded video is performed dynamically, in response to a real-time stimulus.

5. The method of claim 1 wherein at least one of said first pre-encoded video and said second pre-encoded video further comprise audio.

6. The method of claim 3 wherein said switching is performed in response to a request that the transmitter send intra-encoding.

7. A computer readable medium having computer readable code thereon for providing transmittal of pre-encoded video the medium comprising:
instructions for beginning transmittal of a pre-encoded video;
instructions for switching, during said transmittal of said first pre-encoded video, to a second pre-encoded video at an intra encoding point such that no visual disturbance is received by a receiver of said pre-encoded videos.

8. The computer readable medium of claim 7 further comprising instructions for switching from said second pre-encoded video to said first pre-encoded video at an intra encoding point such that no visual disturbance is received by a receiver of said pre-encoded videos.

9. The computer readable medium of claim 7 wherein said instructions for switching comprise instructions for dynamically switching from said first pre-encoded video to said second pre-encoded video in response to a real-time stimulus.

10. The computer readable medium of claim 8 wherein said instructions for switching comprise instructions for dynamically switching from said second pre-encoded video to said first pre-encoded video in response to a real-time stimulus.

11. The computer readable medium of claim 7 wherein at least one of said first pre-encoded video and said second pre-encoded video further comprise audio.

12. The computer readable medium of claim 9 wherein said instructions for switching are executed in response to a request that the transmitter send intra-encoding.

13. The computer readable medium of claim 7 further comprising:
instructions for encoding a video sequence with a first set of parameters to produce said first pre-encoded video;
instructions for encoding said video sequence with a second set of parameters to produce said second pre-encoded video, said second set of parameters different than the first set of parameters.

14. A computer system comprising:
a memory;
a processor;
a communications interface;
an interconnection mechanism coupling the memory, the processor and the communications interface; and
wherein the memory is encoded with a transmittal of pre-encoded video application that when performed on the processor, provides a process for processing information, the process causing the computer system to be capable of performing the operations of:
beginning transmittal of a first pre-encoded video; and
switching, during said transmittal of said first pre-encoded video, to a second pre-encoded video at an intra encoding point such that no visual disturbance is received by a receiver of said pre-encoded videos.

15. The computer system of claim 14 further comprising switching from said second pre-encoded video to said first pre-encoded video at an intra encoding point such that no visual disturbance is received by a receiver of said pre-encoded videos.

16. The computer system of claim 14 wherein said switching from said first pre-encoded video to said second pre-encoded video comprises dynamically switching from said first pre-encoded video to said second pre-encoded video in response to a real-time stimulus.

17. The computer system of claim 16 wherein said switching from said second pre-encoded video to said first pre-encoded video comprises dynamically switching from said first pre-encoded video to said second pre-encoded video in response to a real-time stimulus

18. The computer system of claim 14 wherein at least one of said first pre-encoded video and said second pre-encoded video further comprise audio.

19. The computer system of claim 14 wherein said switching is performed in response to a request that the transmitter send intra-encoding.

20. The computer system of claim 14 wherein said system is capable of performing the operations of:
encoding a video sequence with a first set of parameters to produce said first pre-encoded video; and
encoding said video sequence with a second set of parameters to produce a second pre-encoded video, said second set of parameters different than the first set of parameters.

21. A system comprising:
an encoder, said encoder receiving raw video and encoding said raw video into a plurality of differently encoded videos; and
a transmitter reading input from said plurality of differently encoded videos and providing a selected one of said differently pre-encoded videos at an output, and wherein said transmitter is capable of switching, during said transmittal of said selected one of said differently pre-encoded videos, to a second one of said differently pre-encoded video at an intra encoding point such that no visual disturbance is received by a receiver of said pre-encoded videos.

22. The system of claim 21 further comprising:
a second encoder, said second encoder receiving an audio signal and providing an encoded audio signal; and
a mixer receiving said encoded audio signal and combining said encoded audio signal with at least one encoded video to provide an encoded video including audio.
